(19) United States
(12) Patent Application Publication
(10) Pub. No.: US 2004/0043853 A1
(43) Pub. Date: Mar. 4, 2004

(54) Clutch arrangement using idler means

(76) Inventors: Trevor Lundstrom, Kewdale (AU); David Lundstrom, Yokine (AU)

Correspondence Address: GREENBLUM & BERNSTEIN, P.L.C., 1950 ROLAND CLARKE PLACE, RESTON, VA, 20191, US

(21) Appl. No.: 10/398,510

(22) PCT Filed: Oct. 16, 2001
(86) PCT No.: PCT/AU01/01300

(30) Foreign Application Priority Data
Oct. 17, 2000 (AU) PR 0814

(51) Int. Cl. F16H 7/08; F16H 7/22

(52) U.S. Cl. 474/101; 474/119

(57) ABSTRACT

Clutch arrangement which includes a movable actuating device and a pivotally mounted idler device. The idler device includes a guide wheel and an idler wheel. The idler wheel is arranged to engage a mechanism which transfers drive between at least two drive mechanisms. The guide wheel is arranged to engage or abut the actuating device. The idler device experiences pivotal motion when the actuating device is moved into engagement with the guide wheel.

### FIELD OF THE INVENTION

The present invention relates to a clutch arrangement. More particularly, the clutch arrangement of the present invention is intended for use in circumstances involving a drive and driven shaft, and the effective transmission of power therebetween.

### BACKGROUND ART

Many items of machinery employ a drive shaft and driven shaft arrangement. In circumstances where the driven shaft carries a heavy weight there is often the need for a clutch arrangement to be provided between the driven and drive shafts to enable initial drive to be transferred effectively to the driven shaft and to prevent damage to the drive shaft and any engine or motor associated therewith upon discontinuance of drive.

As an example, a driven shaft on which is mounted a rotor in a threshing machine may generate a large momentum during operation. If the drive motor is cut during operation the momentum of the thresher rotor will continue to rotate the driven shaft on which it is mounted and potentially cause damage to the drive shaft and the engine associated therewith if there is no clutch arrangement provided therebetween.

Many existing clutch arrangements rely on an idler wheel that impinges on a belt running between a drive pulley and a driven pulley. The idler wheel often impinges upon the belt in a direction causing the belt to bend in a manner for which it was not designed. For example, most belts are constructed and designed to bend in one direction only. If an idler wheel is to impinge upon the belt in the other direction this tends to weaken the belt. In addition, many existing clutch arrangements can cause over-extension of the belt, this again weakening the belt.

The clutch arrangement of the present invention has as one object thereof to overcome substantially, or at least provide a useful alternative to, the above problems associated with the prior art.

The preceding discussion of the background art is intended to facilitate an understanding of the present invention only. It should be appreciated that the discussion is not an acknowledgement or admission that any of the material referred to was part of the common general knowledge in Australia as at the priority date of the application.

Throughout this specification, unless the context requires otherwise, the word “comprise”, or variations such as “comprises” or “comprising”, will be understood to imply the inclusion of a stated integer or group of integers but not the exclusion of any other integer or group of integers

### DISCLOSURE OF THE INVENTION

In accordance with the present invention there is provided a clutch arrangement characterised by an idler means and an actuating means, the idler means further comprising a guide wheel, a pivotal mounting and an idler wheel, the idler wheel being arranged so as to impinge upon a belt or the like transferring drive between at least two pulleys or the like, wherein the idler means and actuating means are arranged such that the guide wheel is engaged with or abutting the actuating means, movement in the actuating means inducing movement in the idler means about the pivotal mounting by way of the guide wheel.

Preferably, the actuating means further comprises a flat portion and a ramped portion, the guide wheel being able to pass along both the ramped and flat portions. Movement of the guide wheel along the flat portion of the actuating plate preferably does not induce pivotal movement in the idler means and consequently the idler wheel, as does movement of the guide wheel along the ramped portion.

The actuating means is preferably slidably supported on a support member. Further, the actuating means has provided therein a guide slot through which is received a remotely mounted guide member. The actuating means preferably has provided thereon a mounting means for a hydraulic or pneumatic ram.

Preferably, the idler means is mounted within the belt or the like such that the idler wheel impinges on the belt or the like in an outward direction.

The idler wheel is preferably rotatably mounted on an idler plate, the idler plate being mounted on the pivotal mounting in a pivotal manner. The guide wheel is preferably mounted on an arm which is also mounted on the pivotal mounting in a pivotal manner.

The idler plate and arm may be independently pivotal about the pivotal mounting to a point in rotation at which the arm impinges upon the idler plate and induces movement therein.

### BRIEF DESCRIPTION OF THE DRAWINGS

The clutch arrangement of the present invention will now be described, by way of example only, with reference to one embodiment thereof and the accompanying drawings, in which:—

FIG. 1 is a side elevational view of a clutch arrangement in accordance with the present invention, shown in position between a drive pulley and a driven pulley of a rotor thresher machine in a substantially ‘slack’ or only partially engaged position; and

FIG. 2 is a side elevational view of the clutch arrangement of FIG. 1, in a “tight” or engaged position.

### Best Mode(s) For Carrying Out the Invention

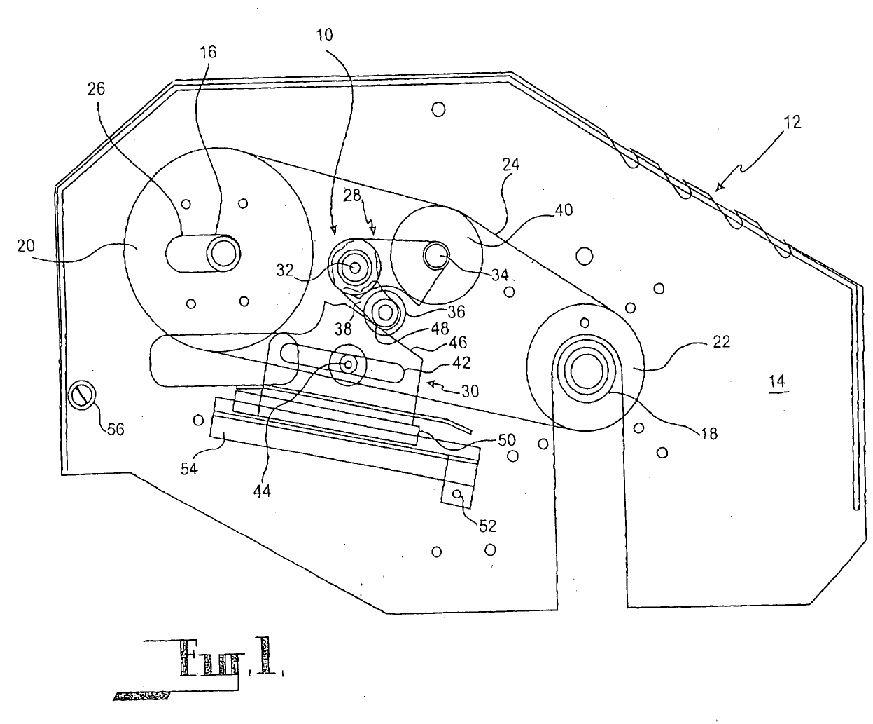

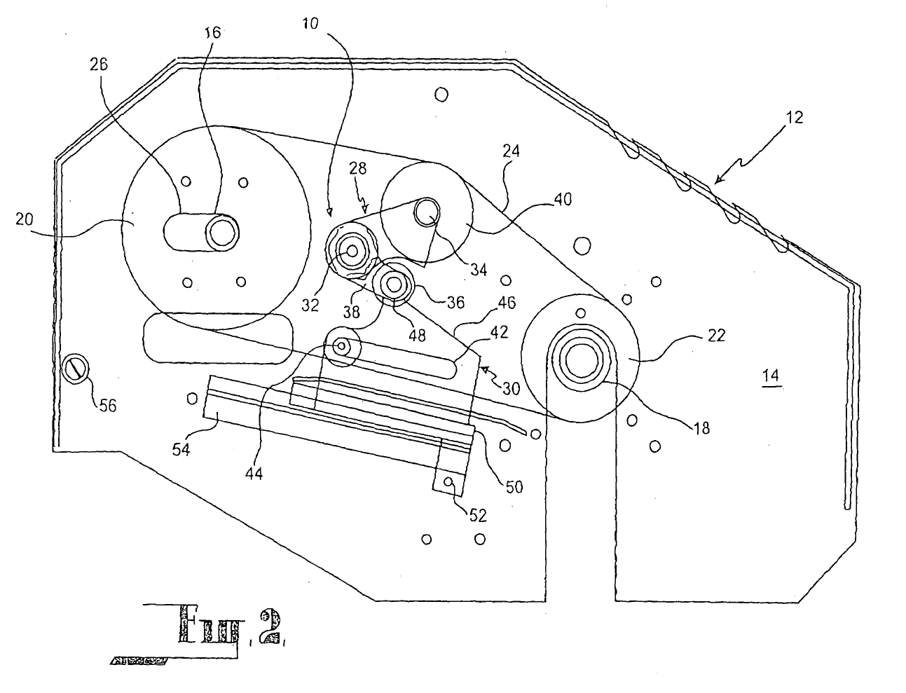

In FIGS. 1 and 2 there is shown a clutch arrangement 10 in position on a thresher rotor machine 12, the machine 12 being shown only in part. The thresher rotor machine 12 comprises an end plate 14 through which projects a drive shaft 16 and a rotor or driven shaft 18. The drive shaft 16 has provided thereabout a drive pulley 20. The driven shaft 18 has provided thereabout a driven pulley 22.

A belt 24 is provided in known manner about the drive pulley 20 and driven pulley 22. Drive is imparted from the drive pulley 20 to the driven pulley 22 through the belt 24. A level of adjustment in the fit of the belt 24 about the pulleys 20 and 22 is provided by way of a slot 26 provided in the end plate 14.

The clutch arrangement 10 comprises an Idler means, for example an idler plate 28 and an actuating means, for example an actuating plate 30. The idler plate 28 is provided with a pivotal mounting 32 to the end plate 14. The idler plate 28 is of generally triangular configuration, the pivotal mounting 32 being provided in one corner thereof, a stub axial 34 being provided in another corner thereof, the remaining corner thereof being cut-away to accommodate a guide wheel 36 which is rotatably mounted on an arm 38 extending from the pivotal mounting 32. The guide wheel 36 is supported by the arm 38 in a manner such that the guide wheel 36 is positioned within the cut-away of the idler plate 28. The stub axial 34 supports rotatably thereon an idler wheel 40. The idler wheel 40 is arranged such that rotation or pivotal movement of the idler plate 28 about the pivotal mounting 32 allows the idler wheel 40 to be moved into and out of forceful engagement with the belt 24.

The actuating plate 30 comprises in part a guide slot 42, through which is received a guide member 44. The actuating plate 30 further comprises a ramped portion 46 and a flat portion 48, the portions 46 and 48 being contiguous. Still further, the actuating plate 30 comprises a skid 50 at a lower end thereof, the skid 50 further having a mounting means 52 depending therefrom. The skid 50 is supported on a support member 54, the support member 54 being mounted upon the end plate 14.

A mounting member or point 56 is provided on the end plate 14 in a position such that a hydraulic or pneumatic ram (not shown) may be mounted therebetween, movement in the ram causing movement of the actuating plate 30 with respect to both the idler means and support member 54.

The support member 54 and the pivotal mounting 32 of the idler plate 28 are arranged such that the guide wheel 36 engages the ramped portion 46 or the flat portion 48 of the actuating plate 30, in use. The guide member 44, in combination with the guide slot 42 in the actuating plate 30, defines the limits of travel of the actuating plate 30 relative to the idler plate 28.

Actuation of the ram induces movement in the actuating plate 30 which is guided by its support on the support member 54 and its engagement with the guide member 44 such that it moves between the drive pulley 20 and the driven pulley 22 in a direction dependent upon whether an operator (not shown) desires that the clutch arrangement 10 be engaged or disengaged from the belt 24.

Movement of the actuating plate 30 towards the driven pulley 22 causes the guide wheel 36 to ride upwardly along the ramped portion 46. This motion causes the idler plate 28 to pivot about the mounting means 32 and pushes the idler wheel 40 into firm engagement with the belt 24, thereby ensuring drive is efficiently imparted from the drive pulley 20 to the driven pulley 22, as shown in FIG. 2.

Beyond the ramped portion 46 the guide wheel 36 passes onto the flat portion 48 of the actuating plate 30. The flat portion 48 ensures that no further rotation of the idler plate 28 is induced and prevents over-extension of the belt 24. This process is simply reversed to disengage the idler wheel 40 from the belt 24 through rotation of the idler plate 28 about the mounting means 32 as the guide wheel 36 passes down the ramped portion 46 of the actuating plate 30.

In light of the foregoing, the clutch arrangement 10 of the present invention can be seen to provide an arrangement in which an idler wheel impinges upon a belt in a preferred direction and consequently avoids weakening of the belt. Further, the present clutch arrangement should not cause over-extension of the belt, again avoiding weakening the belt.

Further, the clutch arrangement 10 of the present invention provides an arrangement able to accommodate use in machinery in which large momentum is generated during use and avoiding damage that may result to the drive shaft and the engine associated therewith.

Modifications and variations such as would be apparent to the skilled addressee are considered to fall within the scope of the present invention.

1. A clutch arrangement characterised by an idler means and an actuating means, the idler means further comprising a guide wheel, a pivotal mounting and an idler wheel, the idler wheel being arranged so as to impinge upon a belt or the like transferring drive between at least two pulleys or the like, wherein the idler means and actuating means are arranged such that the guide wheel is engaged with or abutting the actuating means, movement in the actuating means inducing movement in the idler means about the pivotal mounting by way of the guide wheel.

2. A clutch arrangement according to claim 1, characterised in that the actuating means further comprises a flat portion and a ramped portion, the guide wheel being able to pass along both the ramped and flat portions.

3. A clutch arrangement according to claim 2, characterised in that movement of the guide wheel along the flat portion of the actuating plate does not induce pivotal movement in the idler means and consequently the idler wheel, as does movement of the guide wheel along the ramped portion.

4. A clutch arrangement according to any one of claims 1 to 3, characterised in that the actuating means is slidably supported on a support member.

5. A clutch arrangement according to any one of claims 1 to 4, characterised in that the actuating means has provided therein a guide slot through which is received a remotely mounted guide member.

6. A clutch arrangement according to any one of claims 1 to 5, characterised in that the actuating means preferably has provided thereon a mbunting means for a hydraulic or pneumatic ram.

7. A clutch arrangement according to any one of claims 1 to 6, characterised in that the idler means is mounted within the belt or the like such that the idler wheel impinges on the belt or the like in an outward direction.

8. A clutch arrangement according to any one of claims 1 to 7, characterised in that the idler wheel is rotatably mounted on an idler plate, the idler plate being mounted on the pivotal mounting in a pivotal manner.

9. A clutch arrangement according to any one of claims 1 to 8, characterised in that the guide wheel is mounted on an arm which is also mounted on the pivotal mounting in a pivotal manner.

10. A clutch arrangement according to claim 9, characterised in that the idler plate and arm are independently pivotal about the pivotal mounting to a point in rotation at which the arm impinges upon the idler plate and induces movement therein.

11. A clutch arrangement substantially as hereinbefore described with reference to the accompanying drawings.
